(19) United States
(12) Patent Application Publication
(10) Pub. No.: US 2005/0244159 A1
(43) Pub. Date: Nov. 3, 2005

(54) Optical wavelength-conversion

(76) Inventors: Aref Chowdhury, Springfield, NJ (US); Christopher Richard Doerr, Middletown, NJ (US); Gregory Raybon, Shrewsbury, NJ (US)

Correspondence Address: Lucent Technologies Inc.;Docket Administrator - Room 3J-219, 101 Crawfords Corner Road, Holmdel, NJ, 07733-3030, US

(21) Appl. No.: 10/835,753

(22) Filed: Apr. 30, 2004

(51) Int. Cl. H04J 14/06

(52) U.S. Cl. 398/65

(57) ABSTRACT

An apparatus includes an optical wavelength-converter and a polarization splitter. The polarization splitter is configured to receive input and pump light, to direct a first polarization component of the received input and pump light to a first optical path, and to direct a second polarization component of the received input and pump light to a separate second optical path. The optical wavelength-converter has first and second optical ports. The first optical port is at an end of the first optical path. The second port is at an end of the second optical path. The wavelength-converter outputs wavelength-converted light from one of the ports in response to receiving the input and pump light at the other of the ports. The two optical paths may include polarization-maintaining optical waveguides. The polarization splitter and optical paths may be configured to transmit substantially the same pump light intensity to the two optical ports.

### BACKGROUND

1. Field of the Invention

This invention relates generally to optical communications and more specifically to optical wavelength-converters.

2. Discussion of the Related Art

In fiber-optical communication systems, propagating optical signals often arrive at network nodes with unknown polarizations. For example, polarizations of the arriving optical signals may vary unpredictably in time. The absence of knowledge about the polarizations of the arriving optical signals makes it desirable to process such optical signals in a manner that is insensitive to polarization. For that reason, in-line optical devices for processing optical signals are typically constructed to be polarization-diverse.

In wavelength division multiplexed (WDM) optical communication networks, different optical spans may carry the same data communication signal on different wavelength channels. Thus, WDM optical communication networks often include optical wavelength-converters. For the above-described reasons, these optical wavelength-converters should be polarization-diverse.

To achieve polarization-diversity, some optical wavelength-converters split an arriving optical signal into two orthogonal polarization components and process the two polarization components in separate optical wavelength-conversion media. Ordinary optical wavelength-conversion media are polarization-sensitive. The optical wavelength-converters recombine the light produced in the separate ordinary optical wavelength-conversion media to produce an output optical signal. By splitting, separately wavelength-converting, and then recombining, such optical wavelength-converters can produce optical signals whose power at a converted-wavelength is independent of the polarization of the original arriving optical signal.

Using separate ordinary optical media to wavelength-convert the orthogonal polarization components of an arriving optical signal requires controls. In particular, environmental conditions such as temperature may affect wavelength-conversion in the ordinary optical media. Temporal variations in conditions of the separate optical wavelength-conversion media could destroy the polarization-diversity of the overall optical wavelength-conversion process. To avoid losing polarization-diversity, some optical wavelength-converters include devices that maintain their environmental conditions at constant levels. These environmental control devices are often costly and complex to operate.

### SUMMARY

Various embodiments provide optical wavelength-converters that cause both polarization components of an original optical signal to propagate over the same optical path. The optical wavelength converters use a nonlinear optical medium to wavelength-convert light from both polarization components under substantially the same conditions. Since both polarization components propagate over the same optical path and undergo wavelength-conversion under substantially the same conditions, these wavelength-converters have higher stability against changes to environmental conditions.

In one aspect, an apparatus includes an optical wavelength-converter and a polarization splitter. The polarization splitter is configured to receive input and pump light, to direct a first polarization component of the received light to a first optical path, and to direct a second polarization component of the received light to a separate second optical path. The optical wavelength-converter has first and second optical ports. The first optical port is at an end of the first optical path. The second port is at an end of the second optical path. The wavelength-converter outputs wavelength-converted light from one of the ports in response to receiving part of the input light and part of the pump light at the other of the ports. The first and second optical paths include polarization-maintaining optical waveguides.

In another aspect, an apparatus includes an optical wavelength-converter and a polarization splitter. The polarization splitter is configured to receive input and pump light, to direct a first polarization component of the received light to a first optical path, and to direct a second polarization component of the received light to a separate second optical path. The optical wavelength-converter has first and second optical ports. The first optical port is at an end of the first optical path. The second port is at an end of the second optical path. The wavelength-converter outputs wavelength-converted light from one of the ports in response to receiving the input and pump light at the other of the ports. The polarization splitter and first optical path are configured to transmit one intensity of the received pump light to the first optical port. The polarization splitter and second optical path are configured to transmit substantially the same intensity of the received pump light to the second optical port.

In another aspect, a method provides steps for wavelength-conversion. The steps include splitting input and pump light into orthogonal first and second polarization components, transmitting the first polarization component of the input light to a first end of an optical path, and transmitting the second polarization component of the input light to the second end of the optical path. The steps include recombining the light output at the two ends of the optical path in response to the acts of transmitting. The optical path has a path segment with a nonlinear optical medium for wavelength-conversion. The splitting and transmitting steps cause the path segment to be optically pumped from each end with substantially the same pump light intensity.

### BRIEF DESCRIPTION OF THE DRAWINGS

FIG. 1 is a block diagram for an optical wavelength-converter that is polarization diverse;

FIG. 2 is a flow chart for a method of operating a polarization-diverse optical wavelength-converter, e.g., the optical wavelength converter of FIG. 1, 3 or 4; and

FIG. 3 is a block diagram for an in-line embodiment of the polarization-diverse optical wavelength-converter of FIG. 1;

FIG. 4 is a block diagram for another in-line embodiment of the polarization-diverse optical wavelength-converter of FIG. 1;

In the figures and text, like reference numbers refer to functionally similar features.

Herein, various embodiments are described more fully with reference to accompanying figures and description. The invention may, however, be embodied in various forms and is not limited to the embodiments described herein.

### DETAILED DESCRIPTION OF ILLUSTRATIVE EMBODIMENTS

FIG. 1 shows an optical wavelength-converter 10 that is polarization-diverse. The optical wavelength-converter 10 includes a polarization splitter 12; an ordinary optical wavelength-converter 14; polarization rotators 16, 17; and first and second optical waveguides 18, 20.

Polarization splitter 12 receives light at optical port 22 and splits the received light into orthogonal plane-polarization components. The optical port 22 receives both input light for wave-length conversion and pump light for use in causing the wavelength-conversion. The polarization splitter 12 outputs one plane-polarization component of the received light to optical waveguide 18 via optical port 24 and outputs the other plane-polarization component of the received light to optical waveguide 20 via optical port 26. Exemplary polarization splitters 12 include prisms Nicol, Rochon, Glan-Thompson, and Wollastan prisms, arrayed-waveguide polarization splitters, and other optical polarization splitters known to those of skill in the art.

Ordinary optical wavelength-converter 14 includes an optical waveguide that connects optical port 28 to optical port 30, i.e., a one-dimensional optical waveguide. Exemplary optical waveguides includes a higher refractive index region, which is located in a bulk, planar, or buried structure of a nonlinear optical medium or semiconductor optical amplifier. The optical waveguide includes a nonlinear optical media that may be a periodically-poled or periodically-layered structure. The periodic structure produces quasi-phase matching, which enhances wavelength-conversion at selected input and pump wavelengths. The ordinary optical wavelength-converter 14 may be a generator of harmonic light, a generator of difference frequency light such as an optical phase conjugator, or a generator of another type of wavelength-converted light.

For ordinary optical wavelength-converter 14, exemplary nonlinear optical media include periodically poled lithium niobate; periodically striped gallium arsenides; periodically-polarization-striped group III-nitrides, e.g., gallium-nitrides; and semiconductor optical amplifying media.

Exemplary structures for optical wavelength-converters and fabrication methods for such devices may, e.g., be found in one or more of: U.S. patent application Ser. No. 10/259,051, filed Sep. 27, 2002, by Chowdhury et al. and U.S. Pat. Nos. 5,193,023; 5,355,247; 5,475,526; 6,013,221; and 6,555,293. The above-listed patent application and patents are incorporated herein by reference in their entirety.

The ordinary optical wavelength-converter 14 has an optical port 28, 30 at each end of the internal optical waveguide, which is adapted for wavelength-conversion. For that reason, the ordinary optical wavelength-converter 14 will output wavelength-converted light from either optical port 28, 30 in response to the other optical port 30, 28 receiving input light and being pumped by pump light.

The ordinary optical wavelength-converter 14 has an internal optical axis. If input light and pump light are polarized along the internal optical axis, wavelength-conversion is most efficient. For that reason, the ordinary optical wavelength-converter 14 is not a polarization-diverse optical device.

Optical wavelength-converter 10 includes features that compensate for the non-polarization-diverse character of ordinary optical wavelength-converter 14.

First, optical waveguides 18, 20 and polarization rotators 16, 17 are configured to deliver light to both optical ports 28, 30 so that polarizations are substantially parallel to the internal optical axis of optical wavelength converter 14. The optical waveguides 18, 20 may be specifically configured to maintain the plane polarizations P, P′ received via optical ports 24, 26 of the polarization splitter 12. For example, the optical waveguides 18, 20 may be polarization-maintaining optical fibers (PMFs). In some such embodiments, the PMFs are also oriented to deliver light to optical ports 28, 30 such that the light is polarized along the optical axis of the ordinary optical wavelength-converter 14. In such embodiments, the polarization rotators 16, 17 are absent. In other such embodiments, the PMFs have transverse optical axes that are oriented to launch non-optimally polarized light toward the ends of ordinary optical wavelength-converter 14. In such embodiments, the polarization rotators 16, 17 rotate plane polarizations P, P′ of the launched light so that the polarizations are aligned to the internal optical axis of the ordinary optical wavelength-converter 14 at the optical ports 28, 30. Exemplary polarization rotators 16, 17 are suitably oriented ½ wave plates, optically active media, obliquely oriented mirror pairs, or other known polarization rotators. Typically, the first and second polarization rotators 16, 17 produce relative rotations of approximately 90° so that light is delivered to both ends of the ordinary optical wavelength-converter 14 with the same polarization, e.g., the optimal polarization for optical wavelength conversion therein. Alignment errors between the polarizations of the light and the internal optical axis of the ordinary optical wavelength-converter 14 are 10° or less, preferably are 5° or less, and more preferably are 1° or less.

Second, optical wavelength converter 10 delivers substantially the same pump light intensity to both optical ports 28, 30 of ordinary optical wavelength-converter 14. The ratio of the pump light intensities transmitted to the optical port 28 to the pump light transmitted to the other of the optical port 30 is in the interval [¾, 1.0], preferably is in the interval [0.9, 1.0], and more preferably is in the interval [0.95, 1.0].

In some embodiments, the polarization splitter 12 transmits about the same pump light intensity to each optical port 24, 26. The optical waveguides 18, 20 also transmit received light without significant attenuation so that substantially the same pump light intensity is delivered to both optical ports 28, 30. To transmit about the same pump light intensity to each optical port 24, 26, the polarization splitter 12 may have its internal optical axis aligned at about a 45° angle with respect to the polarization of the received pump light. To avoid significant attenuation, the optical waveguides 18, 20 may be ordinary optical fibers or may be polarization-maintaining optical fibers that are aligned to maintain the polarizations output at the optical ports 24, 26. Here, alignment errors are in the range ±10°, preferably are in the range ±5°, and more preferably are in the range ±1°. The pump light may also be light that is not linearly polarized. Nevertheless, the various embodiments transmit substantially the same pump light intensity to each optical port 28, 30 of the ordinary wavelength-converter 14.

In ordinary wavelength-converter 14, delivering pump light with substantially parallel polarizations and substantially equal intensities to optical ports 28, 30 causes wavelength-conversion in optical wavelength-converter 10 to be polarization-diverse. In particular, a 90 degree rotation of the polarization of plane polarized input light at optical port 22 should produce a 10% or smaller variation in the output optical power of wavelength-converted light from the optical wavelength-converter 10.

In optical wavelength-converter 10, optical port 22 receives input light and transmits output light. Both polarization components travel the same optical paths, i.e., albeit in opposite directions. Both polarization components undergo wavelength-conversion under substantially the same conditions, i.e., substantially the same pump light intensities and polarization orientations in wavelength-conversion media. For these reasons, optical wavelength-converter 10 is less sensitive to changes in environmental conditions than conventional optical wavelength-converters.

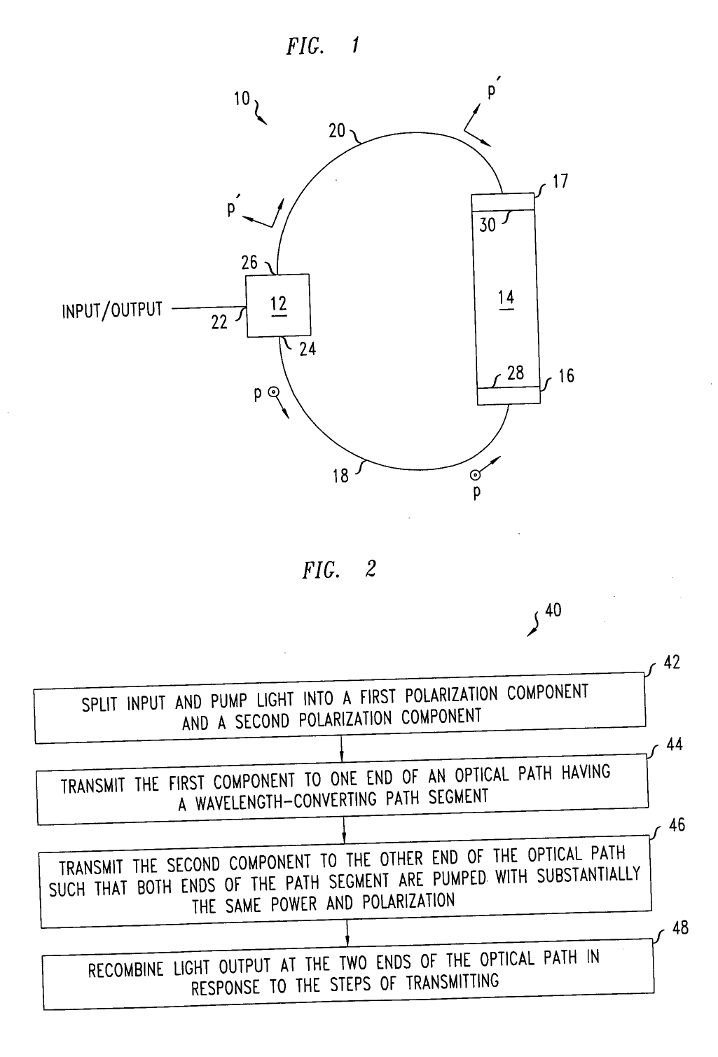

FIG. 2 illustrates a method 40 for performing wavelength-conversion in a polarization-diverse manner, e.g., in a wavelength-converter 10, 10′, 10″ of FIG. 1, 3, or 4. The method 40 includes splitting received input and pump light into a first plane-polarization component and an orthogonal second plane-polarization component (step 42). The first component has a linear polarization that is orthogonal to a linear polarization of the second component. The method 40 includes transmitting the first polarization component of the received light to a first end of an optical path (step 44). The optical path includes a wavelength-converting path segment. The wavelength-converting path segment is an ordinary optical wavelength-conversion medium that is adapted to cause the pump light to wavelength-convert light having the wavelength of the input light, e.g., as in ordinary optical wavelength-converter 14 of FIGS. 1, 3, and 4. The method 40 includes transmitting the second polarization component of the received light to the second end of the same optical path simultaneous to transmitting the first polarization component to the first end (step 46). Furthermore, the transmitting steps cause the two polarization components of the light to have in substantially parallel polarization states in the wavelength-converting path segment. In some embodiments, polarizations of one or both components are rotated prior to insertion into the wavelength-converting path segment to align said polarizations in the wavelength-converting path segment. In some embodiments, one or both components are sent through suitably aligned polarization-maintaining optical waveguides to cause the polarizations of the two components to be parallel in the wavelength-converting path segment.

During the steps of transmitting, pump light having substantially the same intensity and the same polarization optically pumps each end of the wavelength-conversion path segment. Such symmetric optical pumping causes the path segment to wavelength-convert input light, which is traveling in either direction, under substantially the same conditions.

Method 40 includes recombining light that the two ends of the optical path output in response to the steps of transmitting (step 48). The recombined light typically includes input, pump, and wavelength-converted light. In the recombined light, the intensity and quality of the wavelength-converted light is substantially independent of the polarization of the original input light so that the method 40 is polarization-diverse.

In method 40, wavelength conversion remains polarization-diverse as environmental conditions change due to two features. First, both polarization components traverse substantially the same optical path between the steps of splitting and recombining. Second, both polarization components undergo wavelength-conversion under substantially the same conditions.

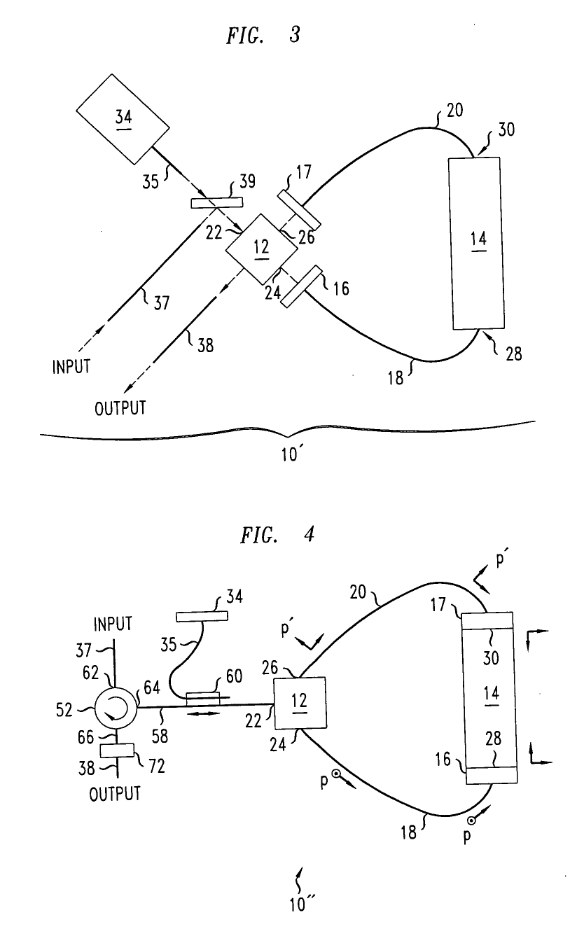

FIGS. 3 and 4 show in-line embodiments 10′, 10″ for WDM optical communication networks of wavelength-converter 10 of FIG. 1.

FIG. 3 shows an in-line optical wavelength-converter 10′ that is polarization-diverse. The optical wavelength-converter 10′ includes polarization splitter 12; ordinary optical wavelength-converter 14; Faraday optical rotators 16, 17; and polarization-maintaining optical fibers 18, 20 as already described with respect to optical wavelength-converter 10 of FIG. 1. Here, the optical rotators 16, 17 rotate polarizations of light received from the polarization splitter 12 by 45° up to rotation errors of 5° or less and preferably of 1° or less. The optical rotators 16, 17 transmit the polarization-rotated light to PMFs 18, 20. The PMFs are oriented to maintain the polarizations of the light incident thereon. The PMFs 18, 20 are also oriented to deliver the light to optical ports 28, 30 of the ordinary optical wavelength-converter 14 so that the polarizations of the delivered light are oriented along the internal optical axis of the ordinary wavelength-converter 14.

Optical wavelength-converter 10′ also includes pump laser source 34, pump optical fiber 35, input optical fiber 37, output optical fiber 38, and dichroic slab 39. The laser source 34 produces pump light for use in wavelength-conversion. The pump optical fiber 35 is a PMF that delivers pump light to the dichroic slab 39 with a selected polarization. The input optical fiber 37 delivers input light to the dichroic slab 39. The dichroic slab 39, which may, e.g., be a thin film device, selectively transmits light at the wavelength of the pump laser source 34 and selectively reflects light at the wavelength of the input light. That is, the dichroic slab 39 is configured to direct both the pump light and the input light toward optical port 22 of polarization splitter 12. The pump optical fiber 35 is oriented to emit pump light whose polarization makes an angle of 45°±5° or 45°±1° with respect to the internal optical axis of the polarization splitter 12 at optical port 22. For that reason, the polarization splitter 12 transmits substantially the same intensity of pump light to each optical port 24, 26. Since the optical fibers 18, 20 are oriented to maintain polarizations of light received from the optical rotators 16, 17, these optical fibers 18, 20 deliver received pump light intensities to optical ports 28, 30 without substantial attenuation. Since each optical fiber 18, 20 receives substantially the same intensity of pump light, the optical fibers 18, 20 deliver substantially the same pump light intensity to each optical port 28, 30 of ordinary optical wavelength-converter 14.

The optical fibers 18, 20 close an optical loop between optical ports 24, 26. In the optical loop, the optical fibers 18, 20 deliver light received from the ordinary optical wavelength-converter 14 to the optical rotators 16, 17 and thus to polarization splitter 12. Around the optical loop, an overall polarization rotation of about 90° occurs, e.g., due to the non-reciprocity of the Faraday effect in the optical rotators 16, 17. This polarization rotation causes the polarization splitter 12 to redirect light, which is received from the loop, to output optical fiber 38 rather than back to optical port 22.

In optical wavelength converter 10′, different polarization components of input light do not co-propagate in PMF. In particular, pump optical fiber 35, which is a PMF, only carriers pump light, and optical fibers 18, 20, which are PMFs, only carry a single polarization component of the input light. For these reasons, the input light does not undergo significant polarization-mode dispersion (PMD) in the optical wavelength-converter 10′. Low or zero PMD is desirable in WDM optical communication networks operating at high data rates, because PMD can be a significant limitation on optical data transmission rates.

Some embodiments of optical wavelength-converter 10′ of FIG. 3 have additional improvements. For example, a dichroic slab may be inserted between the optical output of polarization splitter 12 and output optical fiber 38 in order to reject left-over pump light. Also, the two optical Faraday rotators 16, 17 may be replaced by a single optical device that produces a rotation of about 90°. Also, the polarization splitter 12 may be a walk-off crystal rather than the polarization splitter cube shown in FIG. 3. For such a polarization splitter 12, the Faraday optical rotators 16 and 17 may be replaced by a single Faraday optical rotator, because optical outputs 24, 26 can transmit light to different locations on the single Faraday optical rotator.

FIG. 4 shows a second in-line optical wavelength-converter 10″ that is polarization-diverse. The optical wavelength-converter 10″ includes a polarization splitter 12; an ordinary optical wavelength-converter 14; optical rotators 16, 17; and polarization-maintaining optical fibers 18, 20 as already described with respect to optical wavelength-converters 10, 10′ of FIGS. 1 and 3. The optical wavelength-converter 10″ also includes optical circulator 52, pump laser source 34, pump fiber 35, connecting optical waveguide 58, and optical fiber connector 60.

Optical circulator 52 has three, ordered, optical ports 62, 64, 66. The first optical port 62 receives input light from input optical fiber 37 of a WDM optical communication network. The second optical port 64 transmits the input light to a first end of optical waveguide 58. The third optical port 66 transmits light received at the second optical port 64 to output optical fiber 38 of the WDM optical communication network.

Pump laser source 34 transmits linearly polarized pump light to optical pump fiber 35, which in turn transmits the pump light to optical fiber connector 60. The pump fiber 35 and the optical fiber connector 60 are polarization-maintaining waveguides whose transverse optical axes are aligned to efficiently deliver linearly polarized pump light to optical waveguide 58.

Optical waveguide 58 is a polarization-maintaining optical waveguide, which connects the second optical port 64 of optical circulator 52 and optical fiber connector 60 to optical port 22 of polarization splitter 12. The optical port 22 functions as both an optical input, which transmits input and pump light to the polarization splitter 12, and as an optical output, which receives a mixture of input, pump, and wavelength-converted light from the polarization splitter 12. The polarization-maintaining optical waveguide 58 has its transverse optical axis aligned to deliver pump light to optical port 22 so that the polarization splitter 12 splits the delivered pump light intensity substantially equally between optical waveguide 18 and optical waveguide 20.

The optical waveguides 18, 20 are also PMFs whose transverse optical axes are aligned to deliver substantially equal pump light intensities to each side of ordinary optical wavelength-converter 14. One or two optical rotators 16, 17 may produce polarization rotations so that polarizations of light emitted from the optical waveguides 18, 20 are substantially aligned with the internal optical axis of ordinary optical wavelength-converter 14 at optical ports 28, 30. The optical axis of ordinary optical wavelength-converter 14 may also be oriented so that both PMFs 18, 20 deliver light polarized along said optical axis.

The optical waveguides 18, 20 also deliver light from the ordinary optical wavelength-converter 14 to polarization splitter 12. Optical splitter 12 transmits the light, which is delivered to optical ports 24, 26, to optical port 22. From optical port 22, optical waveguide 58 transports light to second optical port 64 of optical circulator 52. From the second optical port 64, the optical circulator 52 transmits light to optical port 66, which connects to output optical fiber 38.

Some embodiments of in-line optical wavelength-converter 10″ also include one or more band pass optical filters 72 inserted between the third optical port 66 of optical circulator 52 and output optical fiber 38 of the WDM optical communication network. The band pass optical filter 72 removes light having a wavelength of the input or pump light. Then, the output optical fiber 38 of the WDM optical communication network receives substantially only light at the selected converted-wavelength, which is produced in ordinary optical wavelength converter 14.

Referring to FIGS. 3 and 4, in-line optical wavelength-converters 10′, 10″ are substantially insensitive to environmental conditions and are polarization diverse for two reasons. First, both polarization components circulate along the same optical path in the optical wavelength-converters 10′, 10″. Second, input light is subject to substantially the same wavelength-converting conditions in these optical wavelength-converters 14. In particular, pump light of substantially the same polarization and intensity is launched into each end of ordinary optical wavelength-converter 14. Furthermore, input light is launched into each end of the ordinary optical wavelength-converter 14 with substantially the same polarization.

Other embodiments of the invention will be apparent to those skilled in the art in light of the specification, drawings, and claims of this application.

1. An apparatus, comprising:
a polarization splitter configured to receive input and pump light, to direct a first polarization component of the received input and pump light to a first optical path, and to direct a second polarization component of the received input and pump light to a separate second optical path;
an optical wavelength-converter having first and second optical ports, the first port being at an end of the first optical path, the second port being at an end of the second optical path, the wavelength-converter being configured to output wavelength-converted light from one of the ports in response to receiving the input and pump light at the other of the ports;
wherein the first optical path comprises a polarization-maintaining optical waveguide; and
wherein the second optical path comprises a polarization-maintaining optical waveguide.

2. The apparatus of claim 1, wherein the polarization splitter and first optical path are configured to transmit one intensity of the pump light to the first optical port; and
wherein the polarization splitter and second optical path are configured to transmit substantially the same intensity of the pump light to the second optical port.

3. The apparatus of claim 1, wherein a ratio of the intensity of the pump light transmitted to the first optical port to the intensity of the pump light transmitted to the second optical port is in a range of (¾) to 1.0.

4. The apparatus of claim 1, further comprising an optical element that is configured to transmit a single, selected, plane-polarization state of the pump light to an input port of the polarization splitter.

5. The apparatus of claim 4, wherein the optical element comprises a polarization-maintaining optical waveguide.

6. The apparatus of claim 4, wherein the state has a polarization oriented at an angle of 45°±5° to an optical axis of the polarization splitter.

7. The apparatus of claim 1, wherein at least one of the optical paths comprises a Faraday rotator.

8. The apparatus of claim 7, wherein the optical paths are configured to deliver polarized light to the splitter such that the delivered polarized light exits the splitter from a different optical port than an optical port of the polarization splitter that received the input light.

9. An apparatus, comprising:
a polarization splitter configured to receive input and pump light, to direct a first polarization component of the received input and pump light to a first optical path, and to direct a second polarization component of the received input and pump light to a separate second optical path;
an optical wavelength-converter having first and second optical ports, the first port being at an end of the first optical path, the second port being at an end of the second optical path, the wavelength-converter being configured to output wavelength-converted light from one of the ports in response to receiving the input light and pump light at the other of the ports;
wherein the polarization splitter and first optical path are configured to transmit an intensity of the received pump light to the first optical port; and
wherein the polarization splitter and second optical path are configured to transmit substantially the same intensity of the received pump light to the second optical port.

10. The apparatus of claim 9, wherein a ratio of the intensity of the pump light transmitted to the first optical port to the intensity of the pump light transmitted to the second optical port is in a range of (¾) to 1.0.

11. The apparatus of claim 9, wherein a ratio of the intensity of the pump light transmitted to the first optical port to the intensity of the pump light transmitted to the second optical port is in a range of 0.9 to 1.0.

12. The apparatus of claim 9, further comprising an optical element that is configured to transmit a single, selected, plane-polarization state of the pump light to an input port of the polarization splitter.

13. The apparatus of claim 12, wherein the selected, plane-polarization state has a polarization oriented at an angle of 45°±5° to an optical splitting axis of the polarization splitter.

14. The apparatus of claim 9, wherein the first and second optical paths comprise polarization-maintaining optical waveguides.

15. The apparatus of claim 9, wherein the optical wavelength-converter comprises periodically-poled lithium niobate, polarization-striped group III-nitride, or striped group III-V semiconductor.

16. A method for wavelength-conversion, comprising:
splitting received input and pump light into a first polarization component and a second polarization component;
transmitting the first polarization component to a first end of an optical path having a path segment, the path segment being a nonlinear optical medium configured for wavelength-conversion;
transmitting the second polarization component to the second end of the optical path; and
recombining light output at the two ends of the optical path in response to the acts of transmitting; and
wherein the splitting and transmitting steps cause the path segment to be optically pumped from each end thereof with substantially the same pump light intensity.

17. The method of claim 16, wherein the splitting and transmitting steps cause the path segment to be optically pumped from both ends with substantially the same pump light polarization.

18. The method of claim 16, wherein a ratio the intensity of the pump light pumping from one end of the path segment to the intensity of the pump light pumping from the other end of the path segment is in a range of (¾) to 1.0.

19. The method of claim 16, wherein the splitting further comprises sending the pump light through an optical element that selectively passes a single plane-polarization, the optical element coupling to an input of a polarization splitter that performs the splitting.

20. The method of claim 16, wherein the optical path includes a polarization-maintaining optical waveguide between the first end and the path segment and the optical path includes a polarization-maintaining optical waveguide between the second end and the path segment.
